(19) United States
(12) Patent Application Publication
(10) Pub. No.: US 2006/0185639 A1
(43) Pub. Date: Aug. 24, 2006

(54) Modular intake system

(75) Inventor: Amir Rosenbaum, Los Altos Hills, CA (US)

Correspondence Address: THE HECKER LAW GROUP, 1925 CENTURY PARK EAST, SUITE 2300, LOS ANGELES, CA, 90067, US

(73) Assignee: Spectre Industries, Inc., Ontario, CA (US)

(21) Appl. No.: 11/062,316

(22) Filed: Feb. 18, 2005

(51) Int. Cl. F02M 35/10; F16L 11/14; B21K 3/00

(52) U.S. Cl. 123/184.21; 123/184.61; 138/120; 29/888.01

(57) ABSTRACT

A modular air intake system is presented. The system comprises a variety of modular components that may be coupled together to form a desired air intake system configuration for an automobile engine. Each modular component has a plastic structure with chrome plating, resulting in improved insulation and heat reflection characteristics for better engine performance. An intake system may be configured to fit into virtually any automobile engine compartment, because the components may be coupled in any combination, and the angular connection relationship between any two components is adjustable. A locking split-collar may be used to lock the junctions between modular components to provide a fixed configuration.

### FIELD OF THE INVENTION

This invention relates to the field of automotive apparatus. More specifically, the invention relates to intake systems for automobile engines.

### BACKGROUND

The vast majority of current automobile engines are internal combustion engines that operate on a fuel comprising a mixture of gasoline and air. The combustion of the fuel is used to drive an array of pistons or rotors. Through a variety of mechanical means, the combined kinetic energy of the piston or rotor array is applied to the drive shaft of the automobile in a controlled manner to rotate the wheels and move the automobile.

More specifically, within a typical automobile engine, the gasoline-air mixture is introduced to a cylinder chamber, within which the mixture is compressed by the inward motion (or “stroke”) of a piston or rotor. At an optimal point in the “compression stroke,” a spark plug creates an electrical spark within the chamber, igniting the fuel. The combustion of the fuel results in the generation of heat and the expansion of the resulting hot gases in the chamber. This expansion forces the piston outward or spins a rotor. The combustion gases are subsequently vented, and more fuel-air mixture is introduced for the next stroke. Valves (or in the case of a rotary engine, the rotor itself) control the intake of air-fuel mixture and allow the exhaust gases to exit at appropriate times.

The gasoline is stored in liquid form in the fuel tank of the automobile; however, the air component is obtained from the ambient air of the external environment via an air intake system. The temperature of the air obtained via the intake system affects the performance of the engine, because it affects the density of the air in the gasoline-air mixture. With a relative increase in temperature, the decreased input air density translates to a less efficient and less complete combustion process (e.g., due to the decreased availability of oxygen), as well as decreased post-combustion gas volume, resulting in reduced power and fuel economy. Unfortunately, many air intake systems, particularly OEM (original equipment manufacturer) systems, have poor heat reflection characteristics, permitting the heat from the engine to penetrate the intake structure and raise the temperature of the ambient air drawn through the system.

In addition, restriction of the air flow through the intake system can decrease engine performance because less air volume passes through the engine per unit time. Since original equipment manufacturer's air intake systems may be more restrictive, some operators modify their engines by replacing the stock intake system with a freer flowing aftermarket cold air intake system to gain horsepower, torque, and throttle response.

An example of a prior art air intake system is illustrated in FIG. 1. Generally, a prior art intake system includes a one-piece molded intake tube section 120, which is custom configured for the space available in the particular automobile model's engine compartment. In addition, boot 110 may be attached to the end of the air-intake tube where the air intake tube connects with the engine. These prior art air intake tubes are generally made from polished aluminum tubing, painted tubing or roto-molded black plastic.

Intake tube section 120 is typically configured for specific automobile models because there is usually limited space in the engine compartment to fit additional/after-market components, and the space that does exist may be constrained to a single physical intake path.

In practice, some of these prior art air intake systems do not always fit perfectly for the specific automobile for which they were designed. For example, the addition of other aftermarket components may have encroached upon the space normally taken by the intake system. The amount of encroachment by other components may be relatively small; however, the fixed configuration of the intake tube may prevent even modest shifts in position or alignment of the intake tube for the purpose of accommodating other components.

Prior art aftermarket air intake systems can be problematic for the operator/owner, the installer and the parts dealer. For the automobile operator, optimum performance may not be obtained from a prior art intake system, because the materials used to form the intake system have suboptimal heat reflection characteristics. Another drawback is that, because prior art intake systems are designed to fit specific automobile and engine models, the availability of the necessary version of the intake system may be an issue, with special ordering adding to installation delays and costs.

For the installer, the size and shape of the intake system can make it difficult to install in the engine compartment without removing (or loosening/moving) a number of other engine components to expose the portion of the engine where the intake system is connected, and the space within the engine compartment where the intake system will reside. Once the intake system is installed, the previously removed (or loosened/moved) engine components must be re-installed as well. The installation of the intake system can thus be undesirably complex and expensive in terms of labor costs.

High-performance air intake systems of the prior art are difficult for parts dealers to keep in stock. Because the intake system includes a large bulky tube component, each intake system takes an inordinate amount of valuable shelf space. Further, it is impractical for a dealer to keep one or more intake systems in stock for each automobile model. For these reasons, parts dealers may keep only a few sample intake systems in stock (or none at all), and relegating most purchases of the intake systems to custom orders from the manufacturers. These drawbacks may diminish the number of intake system sales the dealer might otherwise make, as well as adding to sales administrative tasks through the added management of special orders.

In view of the foregoing difficulties, it would be desirable to have an intake system that can be applied to many different automobile models with the configuration flexibility to allow for alignment modification when used in non-stock engine environments, and with a material composition that optimizes engine performance. It would also be desirable to have an intake system with a smaller form factor for added space efficiency on dealer store shelves to improve dealer's shelf value and product availability.

### SUMMARY OF THE INVENTION

The present invention is directed to a modular air intake system for an automobile. In one or more embodiments of the invention, multiple modular intake component types are provided, including, for example, straight members, angular members, couplers, etc. Multiple modular intake components may be joined together in a variety of configurations to form a complete intake system.

In one embodiment, two modular intake components may be joined together with a separate collar structure. A collar adapter may be implemented to permit a single collar structure to function with multiple intake component sizes (e.g., tube widths). In other embodiments, the ends of two modular components may be configured with interlocking ridges that allow for the two modular components to lock together at one or more angular orientations by application of a twisting movement.

In one or more embodiments, the materials used in construction of the modular components are such that an embodiment of the modular intake system reflects engine heat away from the air inside the intake system, improving engine performance. For example, one embodiment employs a plastic form with metallic plating (e.g., copper and/or chrome nickel plating) to provide an intake system that reflects heat and insulates the intake air, while providing a light-weight and aesthetically pleasing apparatus.

In one or more embodiments, the modular intake components may be coupled together to match the configuration of a stock air intake system from most automobile models, as well as permitting other alternative configurations. In some embodiments, for example, the intake system may be configured to accommodate other components, to enhance the intake system (e.g., by branching to form dual intakes), or to relocate the air intake port within the engine design.

### BRIEF DESCRIPTION OF THE DRAWINGS

FIG. 1 is an illustration of an air-intake system of the prior art.

FIG. 2 is an illustration of multiple modular intake components arranged, in accordance with one or more embodiments of the invention, as an intake system similar in configuration to the system of FIG. 1.

FIG. 3A is an illustration of a side view of straight tube component 250, in accordance with one or more embodiments of the invention.

FIG. 3B is an illustration of the top view of an end section of straight tube component 250, in accordance with one or more embodiments of the invention.

FIG. 3C is a cross-sectional view of straight tube component 250, in accordance with one or more embodiments of the invention.

FIG. 4 is an illustration of a side view of a 90-degree angular tube component 400, in accordance with one or more embodiments of the invention.

FIG. 5 is an illustration of a side view of a 45-degree angular tube component 400, in accordance with one or more embodiments of the invention.

FIG. 6A is an illustration of a side view of a “Y” member component 600, in accordance with one or more embodiments of the invention.

FIG. 6B is an illustration of a top view of a “Y” member component 600, in accordance with one or more embodiments of the invention.

FIG. 7A is an illustration of a perspective view of the split collar 270, in accordance with one or more embodiments of the invention.

FIG. 7B is a side view of split collar 270, in accordance with one or more embodiments of the invention.

FIG. 7C is a cross-sectional view of body 710 of split collar 270, in accordance with one or more embodiments of the invention.

FIG. 8 is an illustration of a perspective view of sensor manifold tube 230, in accordance with one or more embodiments of the invention.

FIGS. 9A and 9B show a perspective view of a manifold tube 240, in accordance with different embodiments of the invention.

FIG. 10 is an illustration of a perspective view of flex cuff 210, in accordance with one or more embodiments of the invention.

FIGS. 11A-11D are top view and cross-sectional illustrations of a configurable filter adapter, in accordance with one or more embodiments of the invention.

FIG. 12 is an illustration of an embodiment of a fully assembled modular intake system, in accordance with one or more embodiments of the invention.

FIG. 13 is a cross-sectional view of two modular intake components, in accordance with one or more embodiments of the invention.

### DETAILED DESCRIPTION

A modular air intake system for an automobile engine is described. In the following description, numerous specific details are set forth to provide a more thorough description of embodiments of the invention. It will be apparent, however, to one skilled in the art that the invention may be practiced without these specific details. In other instances, well known features have not been described in detail so as not to obscure the invention.

In one or more embodiments of the present invention, modular components may be assembled into one of many possible configurations to form an air intake system to fit any one of most automobile models. The modular intake system may be configured, for example, to provide less restricted airflow to the automobile engine, an alternate/additional intake path, and/or a more visually appealing engine compartment (e.g., for show purposes).

In one or more embodiments, components of the air-intake system may be manufactured from a combination of materials that insulates the intake system and reflects heat in the engine compartment away from the incoming air, providing colder air intake to the engine. In addition, those materials may provide an aesthetically appealing appearance to enhance the presentation of the engine compartment. In one embodiment, for example, components are constructed from high grade materials, such as ABS (Acrylonitrile Butadiene Styrene) plastic (e.g., injection-molded) with copper and/or chrome nickel plating.

Embodiments of the present invention provide flexibility to custom design and build a unique system for any automobile by providing components with variable interconnections. One embodiment of the present invention provides the ability to quickly connect and disconnect components using a locking split collar. In addition, each component is configured to couple to other components, the engine and an air filter in infinite number of ways. For instance, in one embodiment, the tube components that are couplable to form the intake tube system are configured to fit together in any rotational alignment. The coupled components may then be fixed in the chosen alignment by the locking split collar. In another embodiment, the ends of each tube component are configured with interlocking ridges that allow for two modular components to lock together at one or more angular orientations by application of a twisting movement.

In one or more embodiments, intake systems for many automobile models may be configured from a limited library of modular intake components. Thus, the modular system may be marketed as individual modular components, which the purchaser may purchase in the types (e.g., straight tubes, bent tubes of varying angles, branching tubes, tubes with sensor ports, etc.) and quantities suited to configure the desired intake system. The dealer may stock a number of each modular component (with or without individual packaging), where each component has a more profit efficient shelf-space form factor than prior art intake systems. For example, in one embodiment, each modular component is seven inches or less in length.

Alternatively, or in addition, in one or more embodiments, the modular components may be sold as a kit that includes sufficient numbers and types of modular components to configure intake systems for a number of automobile models. Because such a kit would service multiple automobile models, a single kit or a small variety of kits could service the majority, if not all, of the market. Further, the modular components in the kit may be packaged more compactly than a non-modular intake system of the prior art. Dealer shelf space may therefore be optimized, and the need for special orders diminished.

The modular structure of the intake system improves the installation process by permitting the intake system to be installed in smaller, more configurable pieces that are more amenable than prior art intake systems to maneuvering within the crowded confines of an engine compartment. Modular components can be installed without removing or adjusting as many (or possibly any) other engine components. The installation process therefore has less impact on the surrounding engine components, and the corresponding labor is reduced.

### MODULAR IMPLEMENTATION OF INTAKE SYSTEM EXAMPLE

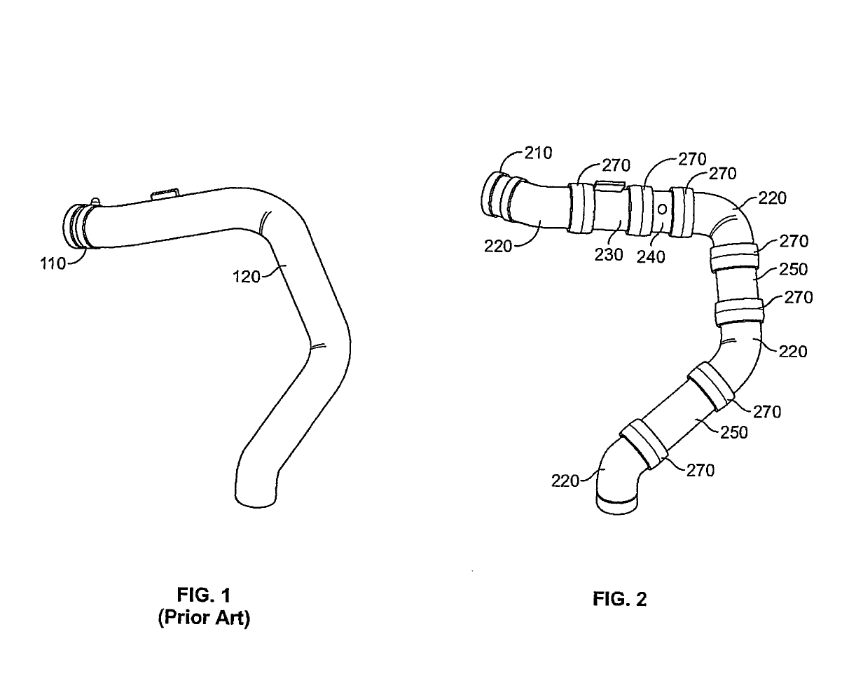

The invention will now be described in detail using FIGS. 2-12. FIG. 2 is an illustration of a modular implementation of the intake system of FIG. 1, using components in accordance with one or more embodiments of the invention. The air-intake system of FIG. 2 includes multiple tube components and clamps configured to replace the air intake system of FIG. 1. Specifically, the intake system shown includes: angular tube components 220; sensor tube component 230; manifold component 240; straight tube components 250; and component interconnects 270 (e.g., split collars and/or interlocked tube junctions using complementary ridges).

As further illustrated in FIG. 2, the air intake system may comprise flexible duct cuff 210. In addition, other component parts and component configurations, beyond those illustrated in FIG. 2, may be included in other embodiments of the invention for constructing a high performance air intake system for any automobile. For instance, a “Y” tube component may also be employed, e.g., to couple dual air filters to an automobile engine.

### EXAMPLES OF MODULAR INTAKE COMPONENTS

The configuration of each of the above components is described fully in the following paragraphs. Though broken down into angular and straight components in the described embodiment, other embodiments may implement modular components that combine the features of two or more of the components described below. For example, in one embodiment, additional or alternative components may be provided that include an angular portion and a straight portion in one contiguous structure. However, modular components with greater atomicity will provide greater configuration flexibility, as well as more profit efficient packaging for dealer shelves.

Also, additional modular components may take advantage of the piecewise design of the intake system for the insertion of functional and/or visually enhancing modular components into the intake system (e.g., to provide active conditioning of the air flow, monitoring of the air flow, or ornamental component shapes or surfaces for show value).

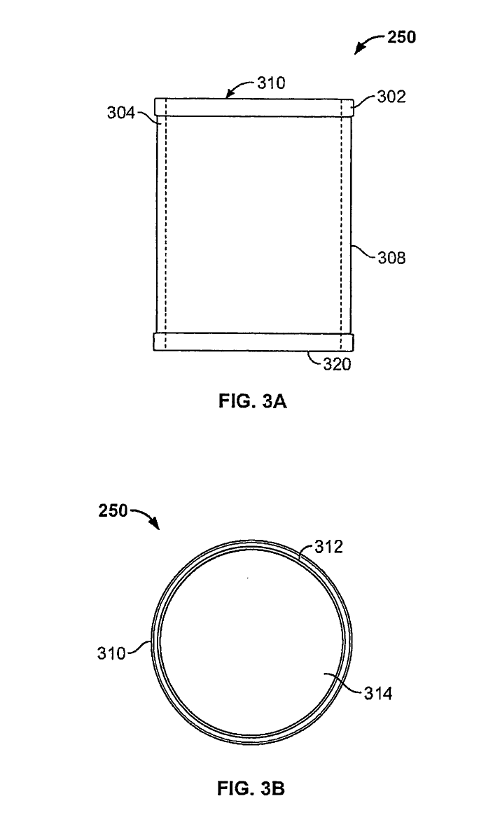

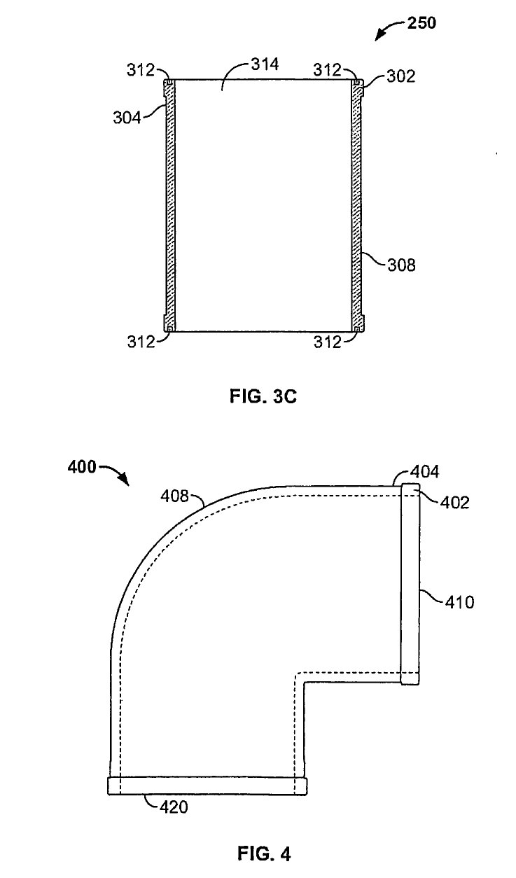

FIGS. 3A, 3B and 3C are illustrations of different views of a straight tube component 250, in accordance with one or more embodiments of the invention. FIG. 3A is a side view of straight tube component 250; FIG. 3B is a top view of an end section of straight tube component 250; and FIG. 3C is a cross-sectional view of straight tube component 250.

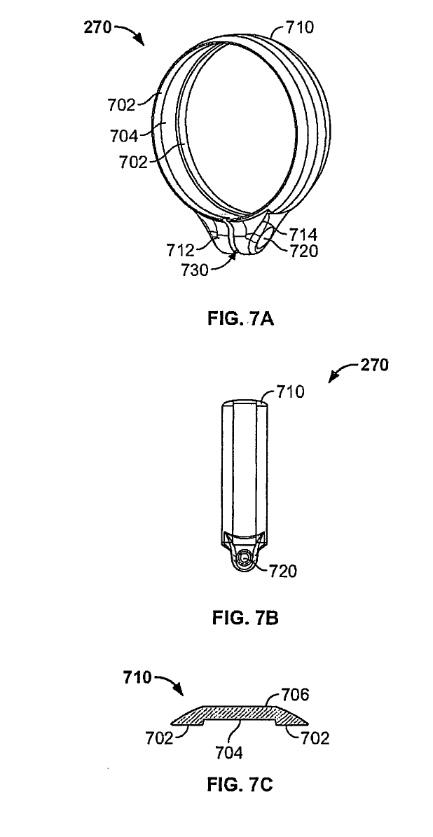

As shown, straight tube component 250 includes cylindrical body 308, a first end section 310, and a second end section 320 that form an air channel 314. Both end sections 310 and 320 are configured similarly to facilitate coupling to any other component of the intake system from either end of straight tube component 250. In the implementation shown, the external surface of each end section of straight tube component 250 is formed with groove and/or ridge structures to receive complementary ridge and/or groove structures on one-half of the inside surface of a coupling structure (e.g., a locking split collar; see FIGS. 7A-7C).

For instance, in the embodiment presented in FIGS. 3A-3C, end section 310 is configured such that the outside diameter of section 302 is slightly larger than the outside diameter of section 304 of the straight tube component 250. Section 304 may have the same outside diameter as the main body section 308, as shown, in one or more embodiments. In other embodiments, section 304 may have a larger or smaller outside diameter than body section 308. In addition, in some embodiments, section 304 may include further ridges or grooves to engage opposing grooves and ridges on the inside of a split collar.

The larger outside diameter of section 302 provides for locking between any two components coupled together with split collar 270. In addition, straight tube component 250 may include an annular channel 312 at each end, e.g., for the insertion of gaskets to create a better seal at the junction between intake components.

The basic structure of straight tube component 250 may be embodied in multiple modular components having varying lengths (e.g., two, three, four and six inch lengths) to meet different configuration needs, and/or varying diameters (e.g., three inches and four inches) to meet varying flow requirements. It is also within the scope of the invention that a straight modular component may be manufactured with other than a circular cross-section through some portion of its central structure. For example, to provide an interesting appearance in a show car, a triangular, split-channel, twisted, ribbed or other cross-sectional design may be embodied in an otherwise linearly-channeled modular component.

FIG. 4 is an illustration of a side view of a 90-degree angular tube component 400 in accordance with an embodiment of the present invention. As illustrated, angular tube component 400 includes a cylindrical body 408, which affects a bend in the intake channel such that end section 410 and end section 420 are perpendicular to each other. Any form of bend that actualizes the perpendicular relationship between ends 410 and 420 may be embodied in such a modular component without departing from the scope of the invention.

Both end sections 410 and 420 are configured similarly to sections 310 and 320 in straight section 250, with section 402 and section 404 corresponding to section 302 and section 304, respectively. Similarly, angular component 400 may include a channel at each end similar to channel 312. The similarity between the configurations of the end sections allows for fixable coupling of a variety of components of the intake system to form one integrated high performance air intake system, in accordance with embodiments of the present invention.

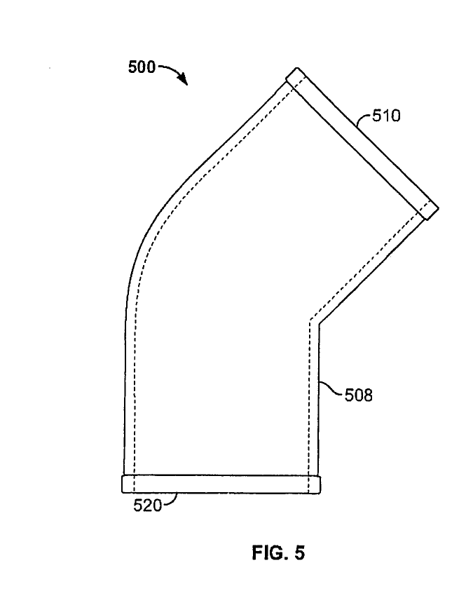

Different versions of angular component 400 may be implemented with varying angles for body 408. For example, whereas the illustration of FIG. 4 represents a ninety-degree angular intake component; the illustration of FIG. 5 represents a forty-five-degree angular intake component (i.e., the angle between the axis for end of 510 and the axis for end 520). Additional angular component versions may also be included. For instance, a 22.5-degree angular member, a 60-degree angular member, etc., may be implemented as part of a library of available modular components.

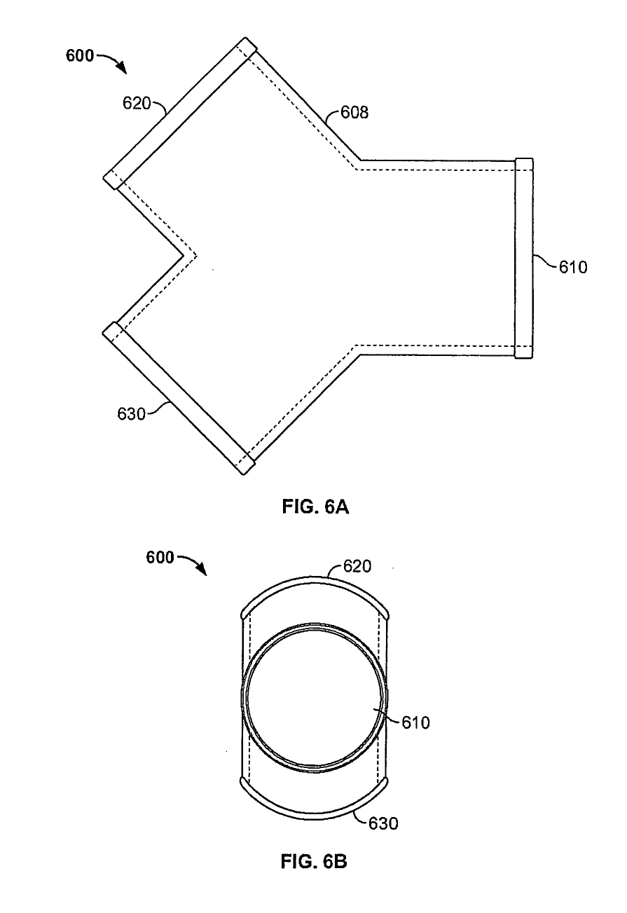

FIGS. 6A and 6B are illustrations of a side view and a top view of a “Y” component 600 in accordance with an embodiment of the present invention. As illustrated, “Y” component 600 comprises a “Y” shaped body 608, a first end section 610, a second end section 620, and a third end section 630.

As with the previously described component embodiments, end sections 610, 620 and 630 are configured to be coupled to another component end section, e.g., with a coupling component such as locking split-collar 270.

FIG. 7A is an illustration of a perspective view of the split collar 270 in accordance with an embodiment of the present invention. FIG. 7B is a side view of split collar 270, and FIG. 7C is a cross-sectional view of body 710 of split collar 270. As illustrated, the inner face of split collar 270 includes twin annular ridges 702 framing central annular groove 704. Annular groove 704 is wide enough to contain the ends of two modular components (e.g., raised sections 302, 402, etc.) when butted together. Each ridge 702 will then abut the adjacent section (e.g., sections 304, 404, etc.) of one of the joined components when the split collar is tightened.

Split collar 270 is configured with a fastener on the outside surface 706 of ring 710. The fastener comprises fastener section 712 opposing fastener section 714 across split 730 of the collar. The fastener sections may include, for example, a bolt and nut combination 720 for locking the split collar. For instance, a bolt may be located in section 714 while the nut is located in section 712. Other locking mechanisms may also be employed, such as spring clips used to lock the collar fastener sections together or to engage the entire collar.

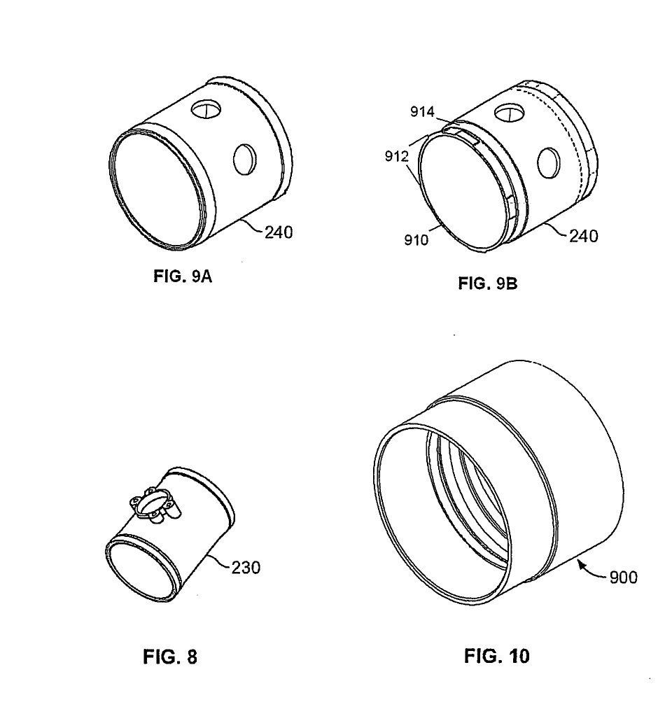

Embodiments of the modular intake system of the present invention may also include a sensor manifold 230, as illustrated in FIG. 8; a manifold 240 as illustrated in FIGS. 9A and 9B; and/or a flex cuff 210 as illustrated in FIG. 10.

Manifold 240 of FIG. 9B is shown with another embodiment of an end configuration, which facilitates module interconnection without use of a split collar or other extra locking device. One (male) end of manifold 240 includes an annular external surface ring 910 having multiple ridges 912 dispersed around the outer circumference. A second (female) end of manifold 240 includes an annular internal surface ring having multiple ridges dispersed around the inner circumference. When the male end of a component is coupled to the female end of another component, the respective ridges of the male and female ends pass between each other, such that when the male end is properly inserted, the ridges of the male end are aligned in an annular groove 914 behind the ridges of the female end, and vice versa. With a twisting motion (partial turn), the male ridges are locked behind the female ridges, providing a fixed connection.

The ridges dispersed around the annular ring may be of differing lengths, and/or with varying distance between respective ridges, such that the two intake components may only be engaged or disengaged at one, or a limited number of angular alignments. The engagement alignment may be indicated by a small arrow or other marking on the outside of each component, where the engagement alignment is formed when the markings for the two components are themselves aligned with each other. The compression fit of the interlocking sections may operate to maintain the components in the desired orientation during use. Additional friction elements, such as small, raised ridges on opposing surfaces of the interlocking component ends, may be employed to ensure retention of the desired orientation during use.

FIG. 13 illustrates an alternative configuration for the junction of modular intake components in accordance with one or more embodiments of the invention. Section 1307 has a slightly larger outside diameter than the outside diameter of Section 1305 and receives complementary groove structures on the inside surface of a coupling structure. In the embodiment illustrated, Part B includes a reduced-diameter coupling section extending beyond raised Section 1307, defining faces 1304 and 1306. Part A has a complementary structure in that Part A has an annular cut-away section configured to receive the reduced-diameter coupling section of Part B. Further, Part A may be configured to include a groove defined by faces 1301 and 1303 (alternatively, Part B may be configured to include such a groove), e.g., for accommodating a sealing element. For example, Rubber O-Ring 1306 may be used to form a seal at the junction between Part A and Part B, compressing against faces 1304, 1301, 1302, 1303 when Part A and Part B are pushed together. A locking collar such as previously described may be used to maintain the integrity of the junction by clamping around respective raised sections 1307.

In the embodiment of FIG. 13, each modular component may be configured with a first end as illustrated for Part A and a second end as illustrated for Part B. Modular components may also be implemented with the same structure on each end, for example, where two versions of each component are available (e.g., a straight component with both male ends and a similar straight component with both female ends). The complete intake structure would then be configured by alternating components of the male and female versions. Other coupling configurations that implement a seal around an O-Ring between two ends of modular intake components may be embodied in such a modular component without departing from the scope of the invention.

The components of the modular intake system previously described (with the possible exception of flex cuff 210) may preferably be made of, or coated with heat reflective material such as chrome or reinforced plastic. Flex cuff 210 is preferably, but not necessarily, made of a durable and flexible material such as plastic.

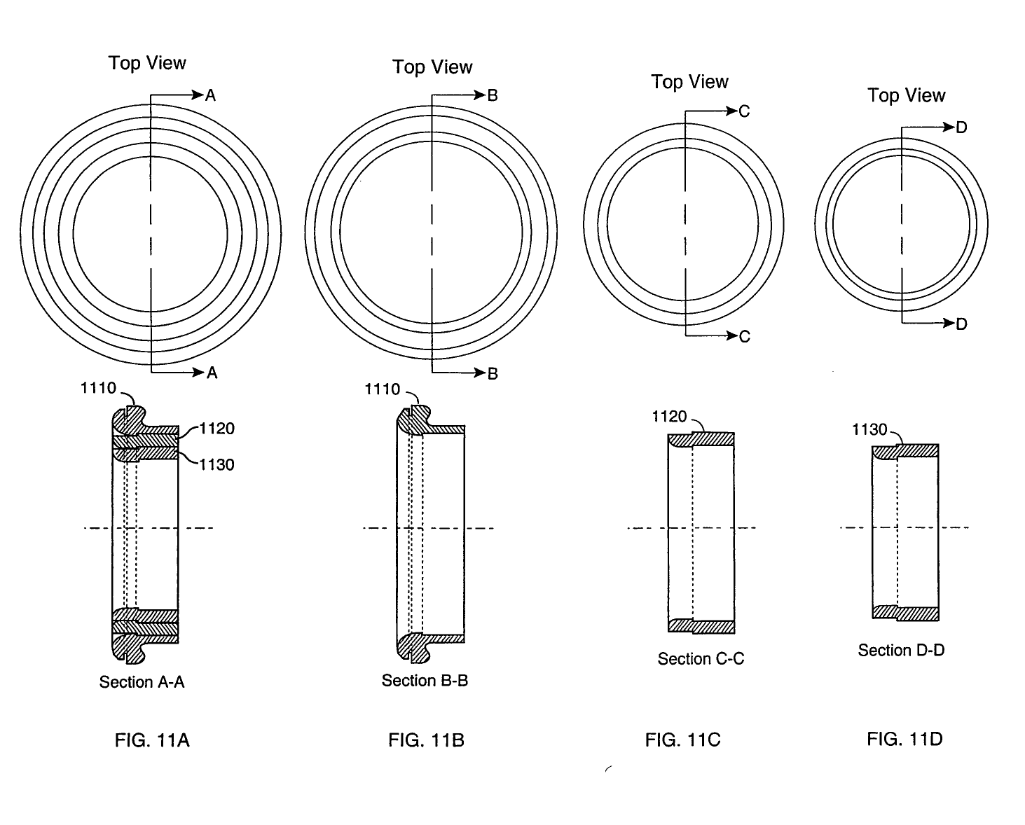

Other components may also be included with the modular intake system. For instance, since an air filter may be attached to one end of the assembled intake system, annular filter adapters such as members 1110, 1120, and 1130 illustrated in FIGS. 11A through 11D (top and cross-sectional views) may be implemented to hold the desired filter in place.

Members 1110, 1120 and 1130 provide varying circumferences for adapting the end of the intake system to match the port of the air filter device, and maintaining the air filter device in position through the friction force present between the surface of the respective adapter and the filter port surface, as well as the friction force between adjacent adapters and between the end component of the intake system and the adapters. Upon insertion of a smaller ring (e.g., 1120) into a larger ring (e.g., 1110), the groove on the smaller ring interferes with the lip on the inside surface of the larger ring, preventing the inner ring from moving past the larger ring. Other configurations that locate and maintain the relative position of these members may be embodied in the filter base adapter component without departing from the scope of the invention.

In one embodiment, adapters 1110, 1120 and 1130 may be constructed from rubber, to provide absorption of vibration, thermal insulation, and effective surface friction characteristics.

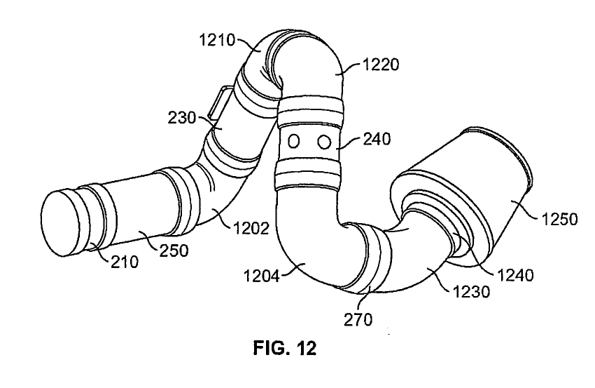

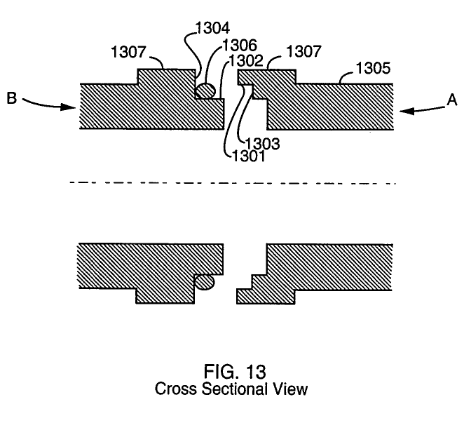

FIG. 12 is an illustration of an embodiment of a fully-assembled modular intake system in accordance with an embodiment of the present invention. As has been described, a highly flexible and adjustable high performance intake system for practically any automobile may be constructed using modular components embodying the present invention. Therefore, just as FIG. 2 illustrates the use of components of embodiments of the present invention to reconstruct a prior art air intake system, FIG. 12 illustrates the infinite configurability of embodiments of the present invention.

In the configuration illustrated in FIG. 12, flex cuff 210 is coupled to a first end of straight member 250, and the second end of straight member 250 is coupled to a first end of ninety-degree angular member 1202 using a first split collar 270. The second end of ninety-degree angular member 1202 is coupled to a first end of sensor manifold 230 using a second split collar 270, and the second end of sensor manifold 230 is coupled to a first end of angular member 1210 using a third split collar 270. The second end of angular member 1210 is coupled to a first end of angular member 1220 using a fourth split collar 270, and the second end of angular member 1220 is coupled to a first end of manifold member 240 using a fifth split collar 270. The second end of manifold member 240 is coupled to a first end of angular member 1204 using a sixth split collar 270, and the second end of angular member 1204 is coupled to a first end of angular member 1230 using a seventh split collar 270. Finally, at the second end of angular member 1230 is coupled a filter 1250 using filter adapter 1240. Filter adapter 1240 may comprise any combinations and configurations of adapters 1110, 1120, and 1130 of FIGS. 11A-11D.

Thus, a modular air intake system has been described. Particular embodiments described herein are illustrative only and should not limit the present invention thereby. The invention is defined by the claims and their full scope of equivalents.

The claimed invention is:

1. A modular air intake system comprising:
a plurality of modular components, wherein each of said plurality of modular components is configured to be couplable to any other of said plurality of modular components; and
wherein said plurality of modular components comprises one or more straight components; and
wherein said plurality of modular components comprises one or more angular components.

2. The modular air intake system of claim 1, further comprising:
a collar for coupling together any two of said plurality of modular components.

3. The modular air intake system of claim 2, wherein said collar is a split collar.

4. The modular intake system of claim 2, wherein at least one end of each of said modular components is configured with an annular ridge, and wherein said collar has an inner groove configured to receive said annular ridge from each of two modular components abutting one another.

5. The modular intake system of claim 2, wherein at least one end of each of said modular components is configured with a depressed annular section, and wherein said collar has two annular ridges configured to sit within said depressed annular region from each of two modular components abutting one another.

6. The modular air intake system of claim 1, wherein said plurality of modular components comprises an air sensor manifold.

7. The modular air intake system of claim 1, wherein said plurality of modular components comprises a “Y” shaped manifold.

8. The modular air intake system of claim 1, wherein each end of each component of said plurality of modular components is configured similarly.

9. The modular air intake system of claim 1, wherein any two ends of any two modular components are configured to interconnect in a plurality of angular alignments.

10. The modular air intake system of claim 1, wherein each of said plurality of hollow tube components comprises a heat reflective material.

11. The modular air intake system of claim 9, wherein said heat reflective material comprises a plastic.

12. The modular air intake system of claim 10, wherein said plastic comprises Acrylonitrile Butadiene Styrene (ABS) plastic.

13. The modular air intake system of claim 10 wherein said plastic is injection-molded.

14. The modular air intake system of claim 9, wherein said heat reflective material comprises a metallic plating.

15. The modular air intake system of claim 13, wherein said metallic plating comprises copper.

16. The modular air intake system of claim 13, wherein said metallic plating comprises nickel chrome.

17. The modular air intake system of claim 1, wherein each of said plurality of modular components is seven inches or less in length.

18. A method for providing an intake system comprising:
obtaining a plurality of modular components comprising a plurality of straight components and a plurality of curved components, each of said plurality of modular components having one or more end sections configured to interconnect with any other of said modular components at a plurality of possible angles around a connection axis.

19. The method of claim 18, further comprising:
forming said modular components from a material comprising a plastic.

20. The method of claim 18, further comprising:
plating said modular components with a metallic material.

21. A method for building an intake system comprising:
determining a connection order of said plurality of modular components to realize a desired intake system design;
adjusting an angular connection alignment between adjacent modular components to realize said desired intake system design; and
locking said plurality of modular components together to maintain said connection order and said angular connection alignment.

22. An intake system kit comprising:
a plurality of straight modular components;
a plurality of curved modular components;
wherein each of said straight modular components and said curved modular components have one or more end sections configured to interconnect with any other of said modular components at a plurality of possible angles around a connection axis.

23. The intake system kit of claim 22, further comprising one or more locking collars.

24. The intake system kit of claim 22, wherein said straight modular components and said curved modular components each comprise a plastic tube structure.

25. The intake system of claim 24, wherein said plastic tube structure is plated with a metallic material.

26. The intake system kit of claim 25, wherein said metallic material comprises copper.

27. The intake system kit of claim 25, wherein said metallic material comprises nickel chrome.
